(19) United States
(12) Patent Application Publication
(10) Pub. No.: US 2005/0077502 A1
(43) Pub. Date: Apr. 14, 2005

(54) Surface reactive preservative for use with solder preforms

(76) Inventor: Gregory C. Munie, Naperville, IL (US)

Correspondence Address: LADAS & PARRY LLP, 224 SOUTH MICHIGAN AVENUE, SUITE 1200, CHICAGO, IL, 60604, US

(21) Appl. No.: 10/682,669

(22) Filed: Oct. 9, 2003

(51) Int. Cl. C09K 3/00

(52) U.S. Cl. 252/380

(57) ABSTRACT

A composition that reacts with and preserves the metal surface of a solder preform and the preserved solder preform are described. The surface preservative composition is compatible with the physical handling of solder performs and the requirements of the soldering process. The composition comprises a carrier, a surface reactive agent, an anti-static agent and a solvent.

### BACKGROUND OF THE INVENTION

1. Field of the Invention

The present invention relates to a composition that reacts with and preserves a solderable metal surface and provides improved handling and solderability of preforms of solderable metal that are to be used in the assembly of electronic packages.

2. Description of the Prior Art

Electronic packaging has been changing rapidly over the last few years. Whereas Dual in Line (DIP) packages were once the primary means of providing an interconnection between a silicon die and a printed wiring assembly, surface mount packages and more specifically surface mount array packages such as Ball Grid Arrays (BGAs), Land Grid Arrays (LGAs), Chip Scale Packages (CSPs), and a variety of odd form components that provide electro-optical interconnections and high frequency/RF functionality are now the dominant packages for today's electronics.

These new packages may incorporate numerous sub-functions within their structure, e.g. the “System in a Package”, (SIP), where a silicon die is combined with numerous supporting sub-components such as resistors, capacitors, etc. Thus, where in the past a soldering operation was primarily concerned with interconnecting an electronic package to a printed wiring board, today's packages may have multiple levels of interconnection provided by multiple soldering processes.

These processes may encompass the use of solder perform to accomplish simple electrical interconnection, physical structure and support, attachment of a silicon die to the internal substrate of the package, sealing of a package cavity against moisture or the outside atmosphere, or provision of a path for thermal energy flow to provide cooling of the package during operation. This variety of operations that a preform may see, coupled with the possibility that a preform may be purchased and stored for some time before use, dictates that the preform meet a number of specialized requirements that exceed the demands on the simpler DIP style silicon die package. In addition, the demands of new package assembly technology are such that, above and beyond the soldering process or processes, a preform may be subjected to considerable storage and physical handling before it is actually employed as part of a soldering process or processes. Thus solder preforms are required to both maintain their soldering properties and be easily handled as their use dictates even under conditions of long term storage.

In the past most preforms were large and bulky. Given that the soldering process was general Environmental pressures have ended most cleaning processes. In addition, the nature of electronics has changed to smaller packages with increased numbers of interconnections,s or replacing the large packages of the past. These interconnections may be internal to the package in a low clearance array geometry during assembly of the package itself. Alternatively, these on interconnections may be made during the attachment of the package to a supporting substrate. In either case the small clearances preclude effective cleaning to remove residues whether they are added to the preforms to enhance its storage and handling characteristics or are added during the soldering operation itself, i.e., a flux. Thus while a no-clean solderable environment might be possible by use of a rosin flux and no coating on the preform, said flux, given its tacky nature, may be unsuitable for today's small geometry, high I/O interconnection packages. In addition, a “no coat” scenario may mean that the handling and storage properties of the preform may be adversely affected prior to the solder assembly operation. As such, that operation, as well as the final assembled product, may be of lower quality than desired.

Thus any preservative used for preforms should meet all or most of the following requirements:
1. It must be compatible with all assembly materials and not act counter to or impede any other materials properties or processes.
2. It is desirable that the selected preservative provides solderability protection such that the desirable soldering properties of the preform do not degrade during storage.
3. The applied preservative must be mobile during application and must be resistant to removal during handling, i.e. it must react with and preserve the preform surface, and must not be degraded with any mechanical processing, e.g. placement, of the preform.
4. The applied preservative must be compatible with mechanical handling of the preform, e.g., it must not powder or flake off the preform, cause the preforms to stick to each other or to processing equipment, or cause static to build up on the preform.
5. The preservative must not be geometry specific, i.e., formulations must be compatible with solder foils, stampings, slugs, columns, spheres, or other shapes as are typically encountered in electronic packaging assembly.

The prior art has addressed the use of protectants applied to the surface of preforms in various shapes, including solder balls used in surface array packages, as previously described, solder bars or ingots and even solder paste.

U.S. Pat. No. 4,243,440 describes a soft solder bar that is coated with an antioxidant layer to prevent formation of surface oxide during storage of the bar. The coating may also act as a solder flux which obviates the need for the use of a separate solder flux in a soldering operation. The coating is a mixture of a neutral ester of a polyhydric alcohol and an ester derived from rosin or from modified rosin.

U.S. Pat. No. 4,298,407 describes tin alloy solder coated with a layer of organic flux, such as mono- and polycarboxylic acids to lower electrical conductivity of and to obscure eutectic domains on the surface of the alloy particles. The organic acid may be dicarboxylic such as salicylic acid, succinic acid, etc. The organic flux may also be an ester, amine, alcohol and phosphate. The organic flux is placed in a carrier medium prior to use. The flux removes oxides from the surface of solder powder. It is applied as a coating and adheres to the surface of a solder particle.

U.S. Pat. No. 4,369,287 describes a method of providing a flux and solder-through coating for electrical components or assemblies wherein a copolymer of ethylene in an organic acid such as acrylic acid is melted and coated on the component or assembly. The copolymer has a molecular weight of about 2,000 to about 3,000 and a density of about 0.93 to about 0.95. The ratio of the ethylene to the acid is about 40/975 to about 160/825.

U.S. Pat. No. 5,225,711 describes a method of flux-less bonding on integrated circuit contacts containing copper wherein a layer of palladium, which inhibits copper oxide formation before fusion, and reduces all oxides to promote wetting during fusion, in the thickness of 200-1500 angstroms.

U.S. Pat. No. 5,328,522 describes solder powders, as a component of solder paste, coated with a protective layer. The solder powders are coated with parylene in order to inhibit oxidation of a solder powder and reaction of the solder powder with the flux in the solder paste without inhibiting the reflow characteristics of the solder.

U.S. Pat. No. 5,789,068 describes a solder preform coated with a predetermined thickness of parylene which protects the preform and provides an optical interference coating which causes the solder preforms to appear green, gold or blue in color. The various colors distinguish different alloy types or customers.

It is unlikely that any prior art preservative or preservative system can meet the requirements specified in the numbered paragraphs above. Therefore, there is a need for a preservative composition that meets those requirements.

### SUMMARY OF THE INVENTION

The novel preservative composition for solder preforms comprises a carrier, one or more surface reactive agents drawn primarily from the class of non-corrosive organic acids, and ionic and non-ionic materials, namely surface active and anti-static agents. The composition is reactive with existing surface metal oxides or is attached chemically to the metal surface through chemical bonding and/or ligand complexation. The preservative composition is dissolved in a suitable solvent for application to the preforms and subsequent evaporation. This surface preservative composition is compatible with the physical handling of the preforms and the requirements of the soldering process, and may contain materials for solderability preservation and static reduction depending on the needs of the preform assembly process.

It is an object of the present invention to provide a reactive composition that preserves the solderability of solder preforms.

Another object of the present invention is to provide a reactive preservative composition that is compatible with known soldering processes for electronic packaging assembly that does not require cleaning after assembly.

Another object of the present invention is to provide a composition that is a durable preservative coating through surface reactivity and chemical binding of coating components to the preform metal surface that does not interfere with the known interconnection processes of the electronic packaging assembly, including interconnection formation, sealing, dye attachment and heat sink attachment/thermal control.

Another object of the present invention is to provide a composition wherein the reactive preservative materials are encapsulated in a carrier to ensure continuous activation as needed even under conditions of long term storage and mechanical handling.

Yet another object of the present invention is to provide a composition wherein the surface activity is a result of bond formation and/or ligand formation between electron donating groups in the coating and the metal surface of the preform.

Another object of the present invention is to provide a method of coating solder preforms with a specific amount of preservative composition so that a sufficient amount of the preservative composition is deposited on the preform so that it remains uniform and allows for surface solderability under typical conditions of long-term storage.

### DETAILED DESCRIPTION OF THE INVENTION

Solder is composed of soft metals, such as tin, lead, bismuth, indium, silver, zinc, and copper of various combinations and percentages, for example (63% tin, 37% lead), (62% tin, 36% lead, 2% silver), (10% tin, 90% lead), (96.5% tin, 3% silver, 0.5% copper), (42% tin, 58% bismuth), and is subject to damage during handling or to rapid reaction with oxygen and/or carbon dioxide in the air, resulting in deterioration that affects performance. Any solder metal can be used in the present invention.

A preform is defined as any shape of a solder metal that has been manufactured with defined dimensions for subsequent mating of that shape with other components of an electronic package. Typically, preforms are used to provide electrical solder interconnections, mechanical support, sealing of packages, and pathways for the flow of thermal energy.

Preformed shapes of solder, such as spheres, stampings, wire segments, etc., are relatively free of contamination on the solder surface when newly manufactured. However, when stored in a non-inert environment, the solder surface over a short time span will become coated with oxide and carbonate that may prevent the bonding of the solder to a metal surface during the solder melting process.

Additionally, transportation and handling of the containers of solder preforms can result in damage of the soft solder metal surface caused by the preforms contacting or rubbing together to damage the surface. Unless packaged in an inert, oxygen-free environment, such as argon or nitrogen, the surface damage can increase the amount of oxidation on the surface, resulting in darkening of the solder surface.

During use of the solder preforms, exposure to air and automated handling equipment can result in more damage or darkening oxidation of the solder surface. In the case of solder preforms that contain lead, hydroxide and carbonate can form on the surface due to exposure to oxygen and carbon dioxide in the air. Automated feeding of solder preforms often employs vibratory bowls with helix tracks on the inside of the bowl. Movement of the solder preforms by vibrating in the bowl and up the helix track further exposes the solder preforms to air and damage from dropping back into the bowl and rubbing against the bowl walls and other solder preforms. Other processes, such as rolling spheres back and forth to fill holes in a platen so the spheres can be placed onto component ball grid arrays also damages and oxidizes the solder surface.

Surface damage and the coating of oxides and carbonates on the solder preforms decreases the reliability of the soldering process when the solder preform is melted with mild fluxes, such as used for electronic applications where solder spheres are melted or soldered onto metal pads of ball grid array (BGA) components. Oxides on the solder metal surface also can cause the preforms to adhere to each other well enough to cause automated feeding problems. Additionally, vacuum pickup devices that pick and place solder preforms may not be able to properly pick up oxidized or surface-damaged solder preforms. When hundreds of solder spheres are being placed onto one component, even one defective soldered sphere will make the entire component non-functional. Other solder preforms, such as washers used to solder pins into a printed circuit board to create a back panel connector board, can create a similar reliability problem if the preforms are oxidized or damaged enough to not fulfill their soldering functionality.

The present invention comprises a water insoluble and abrasion resistant carrier agent, such as a long chain organic acid ester, preferably pentaerythritol tetrastearate, and a surface reactive agent with low or no corrosivity, such as stearic acid, and an anti-static agent can be added as needed but should not impact any of the preferred handling and solderability properties, preferably isooctyl phosphoric acid. Optionally, a solder oxidation inhibitor, such as benzimidazole, can be added to the formulation to protect the preform during long-term storage. For ease of application to the preforms, the preservative materials are dissolved in a suitable volatile solvent, such as isopropyl alcohol.

A) Carriers:

The carrier portion of the preservative is intended to provide a protective matrix that insures the surface reactive agents and preservatives are evenly distributed on and kept in close contact with the preform surface until the assembly. The carrier is either water insoluble or has very limited water solubility. The carrier may be an ester of a polyhydric alcohol, for example, pentaerythritol or glycerol reacted or esterified with a carboxylic acid, such as rosin or hydrogenated rosin, to produce a solid substance at room temperature (25° C.). Other examples of appropriate glycerol esters are the glycerides, such as glycerol mono-, di-, and tri-stearates and palmitates. Pentaerythritol tetrastearate is yet another acceptable carrier, as are the mono- and di-stearates of the polyhydoxy alcohols, ethylene glycol, propylene glycol, and sorbitol. Also functional as carriers are the fatty alcohols with 12 to about 18 carbons, such as lauryl, myristyl, palmityl (cetyl), and stearyl alcohols. Esters of long chain carboxylic acids, said acids typically in the range of 16 to about 26 carbon atoms, also can provide suitable carriers, for example methyl, ethyl, propyl, butyl, and polyglycol, for example, polyethylene glycol, stearates and palmitates, as can the metal salts of said acids, for example tin, lead, cobalt, magnesium, and lithium stearates. Also shown to be beneficial as carriers are polymerized waxy substances with limited solubility in water, such as polylimonene and hydrocarbon microcrystalline wax or petroleum waxes with high molecular weights in the range of about 400 to about 800. The typical weight percent range for the carrier, as measured relative to the total weight of the solids dissolved in the solvent, is about 20% to about 90%.

B) Surface Reactive Agents:

Preferred surface reactive agents are typically drawn from the class of low corrosivity carbonyl/carboxylic agents whose carbonyl/carboxylic groups have good surface binding properties with the preform metal. Corrosivity is defined as the capability of the surface reactive agent to react with and cause thinning or loss of metal. Examples of the carboxylic agents include, but are not limited to, organic dicarboxylic and monocarboxylic acids and their perfluoro analogs. These are chosen for their low corrosivity and compatibility with the required handling properties of the preform. However, use of a water insoluble carrier, as described above, allows the use of water soluble surface reactive agents, for example, lower molecular weight mono- and dicarboxylic acids containing 1 to about 6 carbons, such as butyric, malonic, and maleic acids, without concern for corrosion, i.e. the water insoluble carrier tends to “encapsulate” the reactive agent and limit its reactions with the surface of the preform, thus preventing corrosion. These materials can also be higher molecular weight dicarboxylic and monocarboxylic acids, preferably in the range of about 6 to about 18 carbons, such as azelaic and stearic acids, however, monocarboxylic acids are preferred. Other preferred high molecular weight acids are isophthalic acid and terephthalic acid, undecanoic acid and its perfluoro analog, and the ammonium salts of all the above-mentioned acids. Isooctyl phosphate, and its perfluoro analogs which are commercially available as Crodofos CAP from the Croda Chemical Company have also shown good surface reactive performance. The typical weight percent range for the surface reactive agent, as measured relative to the total weight of the solids dissolved in the solvent, is about 5 to about 80%.

C) Oxidation Inhibitors:

While the present invention is directed to preservative compositions for solder performs, specific oxidation inhibitors, which are optional and not required in the formulation of the present invention, are beneficial for insuring long shelf life of the preforms. Azoles in general, and preferably imidazole, benzimidazole, and urea are preferred, as well as amines of carboxylic acids with carbon chains of 10 to 20 atoms and their perfluoro analogs, preferably perfluoroundecanoic amine. The oxidation inhibitors are especially beneficial when the preforms are of the “lead-free” variety and contain copper and/or silver. As with the lower molecular weight surface reactive agents as described, the use of a water insoluble carrier protects the oxidation inhibitors from removal by interaction with a high humidity environment. The typical weight percent range for the preservatives, when employed and as measured relative to the total weight of the solids dissolved in the solvent, is 0 to about 40%.

D) Anti-Static Agents:

Anti-static agents provide a level of conductivity such that static charge does not build up on the preforms during handling. Typical anti-static materials include the low molecular weight surface reactive agents noted above, their amine salts, and their perfluoro analogs. Preferred anti-static agents are the fatty quaternary ammonium compounds, for example, distearyl dimethyl ammonium ethyl sulfate which is available as Larostat 264A from BASF. The phosphate materials, described above, can also be utilized as anti-static agents. Low levels of amorphous carbon, graphite, and the class of materials known as fullerenes have shown anti-static properties when applied to preforms. Fullerenes are large carbon-cage molecules that are about 7-15A in diameter. The use of these agents must be done in accordance with a change in solvent. Typically, solvents such as toluene and carbon disulfide must be mixed with the carbon before they are added to the other ingredients. The typical weight percent range for the anti-static agents, when employed and as measured relative to the total weight of the solids dissolved in the solvent, is about 1 to about 20%.

E) Solvents:

For ease of application onto the preforms and to promote an even distribution of the coating, the reactive preservative is preferably dissolved in a suitable volatile organic solvent or blend of solvents. Typically the solvent is chosen from the class of lower molecular weight alcohols and esters having molecular weights ranging from about 15 to about 90 such as methanol, ethanol, propanol, isopropanol, methyl acetate and ethyl acetate. The volatile ketone acetone can also be used. These materials provide good solvency and volatility. The solvency is needed to insure that the selected reactive preservative materials can be dissolved in a minimal amount of solvent for environmental and handling reasons. The volatility aids in the efficient processing of the preforms. Volatility is defined for the purpose of this invention as the tendency to rapidly evaporate. From a pragmatic standpoint this means a vapor pressure greater than 2.5 kPa at room temperature (25° C.) and a boiling point below 100° C. The solvents cited above and others with similar properties can thus be considered as having high volatility. Indeed, the solvents quickly evaporate upon application of the preservative composition to the solder preform. The typical weight percent range for the solvents, measured relative to the total weight of all the combined ingredients, is about 60 to about 99%

F) Preparation of Surface Reactive Preservative Composition

The method of preparing the preservative composition is straightforward. The solvent is placed into a mixing bowl, and, while mixing, the solid ingredients, including the carrier composition, the surface reactive agent, and the oxidation inhibitor and anti-static agent, when used, are added to the mixing bowl. The mixture is stirred until the solid ingredients are dissolved. Typically, the concentration of the solids in the solution will be about 0.01 weight percent to about 1.2 weight percent, with about 0.07 weight percent to about 0.26 weight percent being the preferred range.

G) Method of Applying Preservative Composition

The method of applying the preservative composition to solder preforms is quite simple, however, the process should be controlled to ensure there is a uniform layer of the preservative composition on the solder preform to preserve the solderable nature of the preform during subsequent handling and transportation. A suitable amount of the preservative composition applied to the preform will ensure that there will be no damage or oxidation of the solder preform surface, and that there is no flaking off of the preservative composition. The preservative composition of the present invention chemically reacts with the surface of the preform to ensure bonding. The preservative composition may also be applied to the surface of slightly oxidized preforms to arrest the oxidation and to ensure stability to the surface of the preform.

A preferred method of applying the preservative composition to a preform is by spraying the composition onto preforms which are being moved in a manner so there is a uniform coating applied to the preform. A rotation controlled drum is preferred for the application. The drum may have fins attached internally to assist in the agitation of the preforms during tumbling. The rotation and agitation assures full mixing of the solution with the preforms.

A weighed amount of preforms is added to a rotary tumbler container, and a measured amount of surface reactive preservative in solution form, based on the embodiment is added to a sprayer. The most advantageous method of ensuring an even coating is to apply the surface reactive preservative composition in measured amounts. The weighed amount of preforms ensures an even and uniform coating of the reactive preservative solution. The amount of the preservative solution is based on the cumulative surface area of the preforms. The surface area is expressed in terms of equivalent weight based on the alloy density and geometry.

The rotation of the drum is adjusted to a suitable speed for the size and delicacy of the preforms being coated. Preferably, a pressurized gas source may be utilized to spray the solution onto the preforms. The gas pressure forces the coating solution into a mist which is applied to the preforms. The gas may or may not be heated depending on the nature of the preservative composition. The gas may be selected from the group consisting of nitrogen, argon, or helium.

Application of the preservative composition to the preform has shown excellent results when the amount of the preservative composition is in the range of 1 to 90 parts per million based on the total weight of the preforms coated.

Further, the measured preservative composition solution may be added to the weighed amount of preforms in a suitable container to insure uniform coverage of the preforms by the preservative composition. The preforms and preservative solution can then be tumbled while evaporating the solvent to ensure uniform and even coating.

Other forms of applying the preservative composition to preforms include the use of a fluid bed or an air blower, which have been shown to be effective. For light preforms weighing less than about 0.15 gram each which can be suspended in air, the preservative composition can be applied and evaporated in the same step. For heavier preforms, the preservative composition may be pre-applied using a mixing drum, a rotating drum or a shaker table. After mixing, the solvent is evaporated in a fluid bed or in an air blower by forcing air or inert gas through the preforms until evaporation is complete.

Another method of applying the preservative composition to preforms is in a mesh basket or container wherein the basket or container with the measured amount of preforms and preservative solution is placed in a sealed container and agitated until the preservative composition is evenly distributed on the preform. Next, a vacuum is drawn on the sealed container to remove any excess solvent.

Another method of the application of the preservative composition to preforms utilizes a multi-station cylinder where the preforms are loaded into the bottom of a cylinder. Inside the cylinder is a strip fastened to the inner wall traversing helically from the bottom to the top so that as the cylinder rotates, the preforms will travel along the strip from the bottom to the top of the cylinder. The preservative composition is applied onto the preforms at the bottom of the container either through misting or by saturation. As the preforms or spheres travel upward, they are agitated to assure uniform solvent distribution. Removal of any excess solvent can be achieved either by evaporation at the top of the cylinder or in post-operation such as a fluid bed or in an air blower.

Typically, about 1 ml of a 0.13 weight percent preservative composition solution can be added to 100 g of solder spheres and after uniformly coating and reacting with the surface of the preform, preferably, a sphere, will have applied on it levels of about 0.001% concentration ranging from about 70 Å to about 90 Å in thickness.

The following formulation examples are intended to enable those skilled in the art to apply the principles of this invention in practical embodiments, but are not intended to limit the scope of the invention.

### EXAMPLE I

A) A preferred reactive preservative composition in accordance with the present invention comprises by weight 0.24 parts of methyl stearate, 0.25 parts of tin stearate, and 0.51 parts of stearic acid dissolved in 78 parts of isopropanol for ease of application. The composition was formed by stirring the dry ingredients into the isopropanol.

B) This formulation comprises by weight 2.18 parts of methyl stearate, 0.55 parts of isophthalic acid, and 1.39 parts of perfluoro-octanoic acid ammonium salt dissolved in 78 parts of isopropanol. The composition was formed by stirring the dry ingredients into the isopropanol.

C) This formulation comprises by weight 0. parts of polylimonene, 0.5 parts of azelaic acid, and 0.1 parts of urea dissolved in 78 parts of isopropanol. The composition was formed by stirring the dry ingredients into the isopropanol.

D) This formulation comprises by weight 0.01 parts of benzimidazole, and 0.4 parts of perfluoroundecanoic acid, dissolved in 78 parts of isopropanol, which is then mixed with 0.1 parts by weight of a solution comprised by weight of 0.5 parts of C60 fullerene and 99.5 parts toluene.

E) This formulation comprises 0.05 parts of stearic acid and 0.05 of petrolatum wax with an average molecular weight of 500 dissolved in 78 parts of a mixture of equal parts of isopropanol and acetone. The composition was formed by stirring the dry ingredients into the isopropanol/acetone mixture.

F) This formulation comprises 0.1 part of stearic acid and 0.1 part of polyethylene glycol (molecular weight 4000) monostearate dissolved in 78 parts of ethanol. The composition was formed by stirring the dry ingredients into the ethanol.

G) This formulation comprises 0.13 part palmitic acid and 0.13 part of pentaerythritol tetrastearate dissolved in 78 parts propanol. The composition was formed by stirring the dry ingredients into the propanol.

H) This formulation comprises 0.05 parts of stearic acid, 0.1 parts of methyl stearate and 0.02 parts of pentadecafluorooctanoic acid ammonium salt dissolved in 78 parts of isopropanol. The composition was formed by stirring the dry ingredients into the isopropanol.

I) This formulation comprises 0.05 parts of stearic acid, 0.1 parts of methyl stearate and 0.02 parts of perfluoroadipic acid dissolved in 78 parts of isopropanol. The composition was formed by stirring the dry ingredients into the isopropanol.

J) This formulation comprises 0.05 parts of stearic acid, 0.1 parts of methyl stearate and 0.02 parts of benzamidazole dissolved in 78 parts of isopropanol. The composition was formed by stirring the dry ingredients into the isopropanol.

K) This formulation comprises 0.05 parts of stearic acid and 0.05 parts of methyl stearate dissolved in 78 parts of isopropanol. The composition was formed by stirring the dry ingredients into the isopropanol.

### EXAMPLE II

A test was conducted to show the preservative composition of the present invention reacting with the metal surface of a solder preform and not simply coating the preform.

X-ray Photoelectron Spectroscopy (XPS), also called Electron Spectroscopy for Chemical Analysis (ESCA), is a powerful tool for examining solid surfaces. Quantitative information of the elemental composition of a surface and the local chemical environment of the atoms on the surface can be obtained. The monochromatic x-ray beam irradiates the surface in a vacuum chamber and penetrates up to 10 microns into the surface.

Some of the x-ray energy is absorbed, resulting in the emission of photoelectrons (photoemission) that leave the ions with a kinetic energy about equal to the difference between the initial photon energy and the electron binding energy of the element's core electron. This is the ionization energy of an atom in the solid for a particular electron subshell. Every element has unique atomic orbitals, so the binding energy can quantitatively identify which elements are present. Although the x-rays can penetrate deeply into the surface, the photoelectrons may travel only up to 50 Å without being scattered.

Every element, when irradiated with x-ray, exhibits a series of binding energy emissions with varying intensities. For two of the solder metals, lead (Pb) and tin (Sn), specific standard binding energy electron-volts (eV) peaks are selected.

| Element | Atomic Number | Orbital | Binding Energy (eV) |
|---|---|---|---|
| Sn | 50 | 3d5 | 484.6 |
| Pb | 82 | 4f7/2 | 136.2 |

The binding energy of core electrons in a metal surface is very sensitive to a chemical that is bonded to the metal surface. The metal atom will then also be bonded to the chemical coating, resulting in a change in the binding energy of its core electron. A chemical shift is the difference between the energy of a photoelectron line for an element in a compound and the corresponding energy of the element in its pure state. For example, metal atoms that are in the oxidation state, such as when reacted with a cationic chemical coating, exhibit binding energy shifts compared to the pure metal. The chemical shift makes XPS a powerful tool for examining surface chemistry.

If a metal surface is coated with a chemical, the binding energy shift, if any, can be measured by subjecting the coated surface to x-ray irradiation and measuring the photoelectron emissions. The measured binding energy of the core electron specific to the metal will shift up to 10 eV depending on the reaction of the chemical coating material with the metal surface.

If the chemical coating has not reacted with the metal surface, there is very little or no chemical shift. In order to prove that a chemical reaction takes place with specific ingredients of the coating composition and the metal, tests were conducted to show that indeed a chemical reaction does take place between the coating compositions and the solder spheres.

X-ray photoelectron spectroscopy was used to obtain quantitative information of the elemental composition of the surface and the local chemical environment of atoms on the surface. The test instrument was an Omnicron XPS/ESCA spectrograph with a thorium dioxide filament for emitting electrons with a potential up to 15 kV. The source receiver is a 300 watts magnesium anode that emits the soft x-ray radiation of 1486.6 eV for magnesium. The detection of photoelectrons requires that the sample be placed in a chamber capable of high vacuum, less than 10⁻⁹ millibar. This test equipment must use flat surfaces, so samples of Sn63Pb37 solder of dimensions 10 mm×10 mm×4 mm thick were prepared with the coatings listed in Table 1, all coatings being 70 to 90 Å thick. The uncoated solder samples, used as the benchmark standard, were wet polished, cleaned, and sputter etched inside the analysis chamber. Individual uncoated and coated samples were placed into the XPS/ESCA chamber and automatic beam intensity, raster, and signal amplification were applied.

The x-ray beam irradiated and penetrated into the surface of the Sn63Pb37 clean metal and emitted photon energy in accordance with those shown in Table 1, 136.2 eV for lead and 484.6 eV for tin. The chemical shift is the difference between the binding energy of a photoelectron line for an element in a compound and the corresponding energy of the element in its pure state. Two solder metals were utilized as an alloy in the test, lead (Pb) and tin (Sn). Results are shown in Table 1.

TABLE 1

| | Pb | Binding | | Sn | Binding | |
|---|---|---|---|---|---|---|
| | Reference | Energy, | Chemical | Reference | Energy, | Chemical |
| Coating | Peak | eV | Shift, eV | Peak | eV | Shift, eV |
| Sn63Pb37, Clean | 136.2 | 136.2 | — | 484.6 | 484.6 | — |
| Oxalic Acid | 136.2 | 138.9 | 2.7 | 484.6 | 486.6. | 2.0 |
| Stearic Acid | 136.2 | 141.6 | 5.4 | 484.6 | 486.9 | 2.5 |
| Palmitic Acid | 136.2 | 139.0 | 2.8 | 484.6 | 487.0 | 2.4 |
| Perfluoroundecanoic | 136.2 | 139.4 | 3.2 | 484.6 | 486.7 | 2.1 |
| Amine | | | | | | |
| Stearamide | 136.2 | 139.1 | 2.9 | 484.6 | 486.0 | 1.4 |
| Benzimidazole | 136.2 | 138.6 | 2.4 | 484.6 | 486.5 | 1.9 |
| Methyl Stearate | 136.2 | 13.7.0 | 0.8 | 484.6 | 485.6 | 1.0 |
| Silicone | 136.2 | 136.3 | 0.1 | 484.6 | 484.9 | 0.3 |
| Petroleum Oil | 136.2 | 136.4 | 0.2 | 484.6 | 485.1 | 0.5 |

The reference peaks for lead (Pb) and tin (Sn) are easily distinguishable and can be used for identification of these two metals. The various coatings on the metal sample cause a chemical shift, measurable in electron volts differences depending on the reaction of the coating and the metal. The chemical shift for materials coating tin is not as great as for lead, but still significant enough to tell which coatings react. Two of the ingredients of the preferred preservative composition from Example II, stearic acid and methyl stearate, are shown in the table. The carboxylic acids are ingredients with surface reactive properties. The acids, preferably stearic acid, show a significant chemical shift indicating strong chemical bonding to the metal surface. Methyl stearate, on the other hand, exhibited significantly less chemical shift than the surface reactive agents. Methyl stearate is an ingredient that functions as a carrier in the composition. The carrier provides a protective matrix that insures the surface reactive agent is evenly distributed on and kept in close contact with the metal.

Perfluoroundecanoic amine and benzimidazole function as oxidation inhibitors in the composition and do exhibit some chemical bonding as they react with the metal surface. Inert materials, such as silicone and petroleum oil, only coat but do not react with the metal surface, as evidenced by the very low amount of chemical shift. From the data presented in Table 1, it appears that substantial chemical reaction occurs with a chemical shift of 2.0 or more.

### EXAMPLE III

For this test, solder spheres of 20-mil (0.020-inch) were selected as a typical size used by the electronic components industry to attach to a ball grid array. The solder alloy was 63% tin 37% lead. To simulate the loading and rolling action that the spheres would experience with automated and semi-automated placement equipment in an air environment, and to obtain controlled, repeatable results, a variable frequency bowl feeder, Shinko Electric Company, Japan, model ME-14C with C4-S3 speed controller, was used to vibrate the spheres until they traveled up the helix track to the top of the bowl where the spheres dropped back into the bowl. Spheres without a coating were processed in the recycling vibratory bowl for six hours, with samples taken hourly. The spheres progressively darkened fairly evenly with time. See Table 2 for results.

The newly manufactured solder preforms, in this example the spheres, exhibit a bright, light-gray colored, reflective surface. The reflectivity decreases and the color changes from light gray to nearly black as the spheres become more oxidized. To obtain quantitative numbers for comparing samples of various increasing age, grayscale imaging was employed. A quantity of solder preform spheres sufficient to fill a one square inch cavity milled into a tooling plate was used for the imaging. With the employment of uniformly dispersed, diffused lighting, a monochrome (black-and-white) digital camera creates an image for analysis. Computer image-analysis algorithms determine the quantitative numbers for the simulated aging.

Grayscale image-analysis is commonly used in test and inspection equipment for electronic assemblies. The grayscale is a measure of the varying shades or brightness of gray in a scale of 0 to 100 as defined by the International Radio Engineers (IRE). Sometimes, the scale is referred to as the percentage of peak white. So, a grayscale rating of 20, for example, would be considered dark gray, and a grayscale rating of 70 would be considered very light gray.

To accelerate testing of the effectiveness of the reactive preservatives of various compositions, a method was developed. Spheres from the same lot used in the vibratory feeder were processed by shaking in a container and then evaluated as above with the grayscale image analysis. For this test, 20 grams (about 35,000 spheres) of the solder preforms were placed into a 7-milliliter plastic (HDPE) scintillation vial with a screw cap. The vial was placed into a hand motion shaker, also called a cocktail shaker, set at 180-rpm for the various test times. Samples were taken after ten-minute intervals and checked for changes in the grayscale ratings. Table 2 indicates the comparative grayscale ratings for the industrial vibratory feeder, sampled hourly, and the hand motion shaker, sampled every 10 minutes. The statistical correlation between this data shows that 1-hour in the hand motion shaker is equivalent to 14-hours in the vibratory feeder.

TABLE 2
Comparative Grayscale Ratings for Uncoated Spheres

| Sample | Gray Scale Rating | | | | | | | | | | | | | | |
|---|---|---|---|---|---|---|---|---|---|---|---|---|---|---|---|
| Number | Initial | 1 | 2 | 3 | 4 | 5 | 6 | 7 | 8 | 9 | 10 | 11 | 12 | 13 | 14 |
| Vibratory | 69.04 | 56.01 | 48.99 | 44.58 | 41.29 | 38.10 | 33.82 | 30.61 | 27.60 | 25.40 | 24.18 | 23.16 | 22.26 | 21.41 | 20.66 |
| Feeder | | | | | | | | | | | | | | | |
| Hand | 69.04 | 40.69 | 31.81 | 25.43 | 22.78 | 21.51 | 20.68 | | | | | | | | |
| Motion | | | | | | | | | | | | | | | |
| Shaker | | | | | | | | | | | | | | | |

With this knowledge that the hand motion shaker can accelerate the darkening of the spheres, further testing was done to determine the optimum thickness of the reactive preservative.

Solutions were prepared and the spheres were processed to form various increasing amounts of surface reactive preservative on the surface of the spheres. The coating thicknesses are measured by weight percentage, for example, 10-ppm (parts per million) is 0.001 weight percentage. 10-ppm of coating on 63% tin 37% lead solder preforms equates to a thickness of 70-90 angstroms. After being coated, the spheres were submitted for grayscale analysis where it was found that the coating itself to some extent reduced the reflectivity of the sphere metal surface with a consequential increase in the grayscale rating. The spheres were then placed into the hand motion shaker and subjected to the accelerated agitation for 1-hour, 2-hours, and 3-hours, and compared to the same spheres without the coating. Table 3 shows the results.

TABLE 3
Comparative Grayscale Ratings for Coated and
Uncoated Spheres
Grayscale Rating

| Coating | | | | |
|---|---|---|---|---|
| Thickness | Initial | 1 hour | 2 hours | 3 hours |
| None | 69.04 | 20.68 | 20.41 | 19.97 |
| 1 ppm | 66.18 | 32.57 | 29.81 | 25.42 |
| 5 ppm | 65.71 | 52.79 | 47.48 | 44.71 |
| 10 ppm | 63.64 | 56.99 | 52.80 | 50.12 |
| 20 ppm | 60.91 | 51.25 | 48.76 | 47.11 |
| 30 ppm | 57.94 | 46.74 | 43.61 | 41.69 |
| 50 ppm | 59.66 | 45.22 | 37.40 | 36.24 |
| 70 ppm | 58.54 | 41.31 | 34.09 | 31.37 |
| 90 ppm | 57.25 | 41.04 | 32.49 | 27.20 |

By this testing, it can be seen that a coating of reactive preservative from 1-ppm to about 90-ppm improves the performance of the solder spheres by preventing surface oxidation and damage from the agitation experienced during processing. Because the coating is reacting with the solder metal surface, and the reflectivity of the organic coating is lower than that of the solder metal surface, the initial grayscale rating will decrease as the coating thickness increases, resulting in reduced reflectivity of the surface. The thickness in the range between 5-ppm and about 20-ppm provides the best overall protection without interfering with the feeding, placement, and soldering processes. However, as the coating gets thicker than about 30-ppm (approximately 200-250 angstroms), though still providing protection from damage and oxidation of the solder surface, for some applications the excessive coating material can flake off the spheres or cause the spheres to start to adhere together.

While the present invention has been particularly described, in conjunction with the specific preferred embodiments, it is evident that many alternatives, modifications, and variations will be apparent to those skilled in the art in light of the foregoing description. It is therefore contemplated that the appended claims will embrace any such alternatives, modifications, and variations as filling within the truth, scope, and spirit of the present invention. The use of preforms in assembly of electronic packaging necessitates good solderability, good preservation of solderability, and facile handling of the preforms.

1. A reactive preservative composition for preserving the solderability of metal preforms comprising:
a carrier composition;
a surface reactive agent;
an anti static material; and
a solvent.

2. The composition according to claim 1 wherein the carrier composition is selected from the group consisting of esters of long chain carboxylic acids.

3. The composition according to claim 2 wherein the carbon chain of the carboxylic acids is about 16 to 26 carbon atoms.

4. The composition according to claim 2 wherein the carrier composition is selected from the group consisting of metal salts of long chain carboxylic acids.

5. The composition according to claim 4 wherein the carbon chain of the carboxylic acids is about 16 to 26 carbon atoms.

6. The composition according to claim 1 wherein the carrier composition is selected from the group consisting of fatty alcohols with a carbon chain of about 12 to about 18 carbons.

7. The composition according to claim 6 wherein the fatty alcohols are selected from the group consisting of lauryl, myristyl, palmityl, and stearyl alcohols.

8. The composition according to claim 1 wherein the carrier is selected from the group consisting of a polymerized waxy substance and a high molecular weight microcrystalline wax.

9. The composition according to claim 8 wherein the carbon chain length of the high molecular weight microcrystalline wax is about 60 to 100 carbon atoms.

10. The composition according to claim 1 wherein the amount of carrier ranges from about 20% to about 90% by weight.

11. The composition according to claim 2 wherein the carrier composition is selected from the group consisting of methyl stearate, ethyl stearate, propyl stearate, butyl stearate, polyglycol stearate and palmitate.

12. The composition according to claim 4 wherein the carrier composition is selected from the group consisting of tin stearate, lead stearate, cobalt stearate, magnesium stearate and lithium stearate.

13. The composition according to claim 8 wherein the carrier is selected from the group consisting of polylimonene, microcrystalline wax and petroleum waxes with high molecular weight in the range of about 400 to about 800.

14. The composition according to claim 1 wherein the carrier is water insoluble.

15. The composition according to claim 1 wherein the surface reactive agent is a carboxylic acids.

16. The composition according to claim 15 wherein the surface reactive agent is selected from the group consisting of dicarboxylic and monocarboxylic acids.

17. The composition according to claim 16 wherein the surface reactive agent is selected from the group consisting of azelaic and stearic acids.

18. The composition according to claim 15 wherein the surface reactive agents are selected from the group consisting of isophthalic acid, terephthalic acid and undecanoic acid.

19. The composition according to claim 16 wherein the surface reactive agents are selected from a group consisting of perfluoro analog and ammonium salts of dicarboxylic and monocarboxylic acids.

20. The composition according to claim 18 wherein the surface reactive agents are selected from the group consisting of perfluoro analog and ammonium salts of isophthalic acid and terephthalic acid.

21. The composition according to claim 1 wherein the amount of the surface active agent ranges from about 5% to about 80% by weight.

22. The composition according to claim 1 wherein the anti-static material is selected from the group consisting of low molecular weight surface reactive agents, amine salts of surface reactive agents and perfluoro analogs of low molecular weight surface reactive agents, fatty quaternary ammonium compounds, amorphous carbon, graphite and fullerenes.

23. The composition according to claim 22 wherein the amount of the anti-static material is about 1% to about 20% by weight.

24. The composition according to claim 1 wherein an oxidation inhibitor is included in the composition.

25. The composition according to claim 24 wherein the oxidation inhibitor is selected from the group consisting of imidazole, benzymidazole, urea, amines of carboxylic acids have carbon chains of 10 to 20 atoms and perfluoro analogs of the amines.

26. The composition according to claim 25 wherein the oxidation inhibitor is perfluoroundecanoic amine.

27. The composition according to claim 24, wherein the oxidation inhibitor is an azole.

28. The composition according to claim 1, wherein the solvent is selected from the group consisting of an organic solvent or blend of organic solvents.

29. The composition according to claim 28 wherein the solvent is selected from the group consisting of low molecular weight alcohols, esters of low molecular weight alcohols, and volatile ketones.

30. The composition according to claim 29 wherein the solvent is selected from the group consisting of low molecular weight alcohols and esters having molecular weights ranging from about 15 to about 90.

31. The composition according to claim 30 wherein the solvent is selected from the group consisting of methanol, ethanol, propanol, isopropanol, methyl acetate and ethyl acetate.

32. The composition according to claim 29 wherein the solvent is acetone.

33. The composition according to claim 1 wherein the composition chemically reacts with a surface of the metal preforms.

34. A solder preform comprising a solder alloy having a preservative composition on the outer surface of the preform, said composition chemically reacting with a metal of the solder alloy.

35. The solder preform according to claim 34 wherein the preservative composition has a thickness on a surface of the solder alloy from about 1 ppm to about 90 ppm.

36. The solder preform according to claim 34 wherein the solder is composed of metals in various combinations and percentages selected from the group consisting of tin, lead, bismuth, indium, silver, zinc and copper.

37. The solder preform according to claim 34 having a preservative composition comprising a carrier composition, a surface reactive agent and an anti-static agent.

38. The solder preform according to claim 37 wherein the carrier composition is selected from the group consisting of esters of long carbon chain carboxylic acids.

39. The solder preform according to claim 38 wherein the carbon chain of the carboxylic acids is about 14 to 26 carbon atoms.

40. The solder preform according to claim 39 wherein the carrier composition is selected from the group consisting of metal salts of long chain carboxylic acids.

41. The solder preform according to claim 37 wherein the carrier is selected from the group consisting of a polymerized waxy substance and a high molecular weight microcrystalline wax.

42. The solder preform according to claim 41 wherein the the microcrystalline wax has a molecular weight of about 400 to about 800.

43. The solder preform according to claim 37 wherein the amount of carrier ranges from about 20% to about 90% by weight.

44. The solder preform according to claim 37 wherein the carrier composition is selected from the group consisting of methyl stearate, ethyl stearate, propyl stearate butyl stearate, polyglycol stearate and palmitate.

45. The solder preform according to claim 40 wherein the carrier composition is selected from the group consisting of tin stearate, lead stearate, cobalt stearate, magnesium stearate and lithium stearate.

46. The solder preform according to claim 37 wherein the carrier is selected from the group consisting of polylimonene, microcrystalline wax and petroleum wax.

47. The solder preform according to claim 37 wherein the carrier is water insoluble.

48. The solder preform according to claim 37 wherein the surface reactive agent is a carboxylic acid.

49. The solder preform according to claim 48 wherein the surface reactive agent is selected from the group consisting of dicarboxylic and monocarboxylic acids.

50. The solder preform according to claim 48 wherein the surface reactive agent is selected from the group consisting of azelaic and stearic acids.

51. The solder preform according to claim 50 wherein the surface reactive agents are selected from the group consisting of isophthalic acid, terephthalic acid and undecanoic acid.

52. The solder preform according to claim 37 wherein the surface reactive agents are selected from a group consisting of perfluoro analog and ammonium salts of dicarboxylic and monocarboxylic acids.

53. The solder preform according to claim 52 wherein the surface reactive agents are selected from the group consisting of perfluoro analog and ammonium salts of isophthalic acid and terephthalic acid.

54. The solder preform according to claim 37 wherein the amount of the surface active agent ranges from about 5% to about 80% by weight.

55. The solder preform according to claim 37 wherein the anti-static material is selected from the group consisting of low molecular weight surface reactive agents, amine salts and perfluoro analogs of low molecular weight surface reactive agents, fatty quaternary ammonium compounds, amorphous carbon, graphite and fullerenes.

56. The solder preform according to claim 55 wherein the amount of the anti-static material is about 1% to about 20% by weight.

57. The solder preform according to claim 37 wherein an oxidation inhibitor is included in the composition.

58. The solder preform according to claim 57 wherein an oxidation inhibitor is selected from the group consisting of imidazole, benzymidazole, urea, amines of carboxylic acids with carbon chains of 10 to 20 atoms and perfluoro analogs of the amines.

59. The solder preform according to claim 58 wherein an oxidation inhibitor is perfluoroundecanoic amine.

60. The solder perform according to claim 57 wherein the oxidation inhibitor is an azole.

61. The solder perform according to claim 37 wherein the carrier composition is selected from the group consisting of fatty alcohols with a carbon chain of about 12 to about 18 carbons.

62. The solder perform according to claim 62 wherein the fatty alcohols are selected from the group consisting of lauryl, myristyl, palmityl and stearyl alcohols.
